(19) United States
(12) Patent Application Publication
(10) Pub. No.: US 2025/0281890 A1
(43) Pub. Date: Sep. 11, 2025

(54) BUBBLE GENERATING APPARATUS AND FERMENTATION TANK INCLUDING SAME

(71) Applicant: CJ CHEILJEDANG CORPORATION, Seoul (KR)

(72) Inventor: Jae Won OH, Seoul (KR)

(73) Assignee: CJ CHEILJEDANG CORPORATION, Seoul (KR)

(21) Appl. No.: 18/861,851

(22) PCT Filed: Jun. 1, 2023
(86) PCT No.: PCT/KR2023/007491

§ 371 Date: Oct. 30, 2024

(30) Foreign Application Priority Data
Jun. 14, 2022 (KR) 10-2022-0072133

(51) Int. Cl. B01F 27/271; A23C 9/12; B01F 23/231; B01F 27/112; B01F 27/191; B01F 27/90; B01F 101/07; B01F 101/16; C12C 11/00; C12J 1/10; H02K 7/00

(52) U.S. Cl. CPC B01F 27/271; B01F 23/231; B01F 27/112; B01F 27/191; B01F 27/90; H02K 7/003; A23C 9/122; B01F 2101/07; B01F 2101/16; B01F 2215/0427; C12C 11/006; C12J 1/10

(57) ABSTRACT

The present invention relates to a bubble generating apparatus and a fermentation tank including same. The bubble generating apparatus comprises: an impeller unit which is provided so as to rotate about an axis extending in a reference direction and includes a plurality of blades arranged along a circumferential direction centered on the axis; and a stator unit which is disposed outside the radius of the impeller unit and includes a plurality of holes arranged along the circumferential direction. The stator unit may be spaced outward from the blades in the radial direction.

### TECHNICAL FIELD

### Mutual Citation With Related Application

This application claims the benefit of priority to Korean Patent Application No. 10-2022-0072133, filed in the Korean Intellectual Property Office on Jun. 14, 2022, the entire contents of which are incorporated herein by reference.

The present disclosure relates to a bubble generating apparatus and a fermentation tank including the same.

### Background Art

Generally, fermented foods refer to new products or food ingredients that are helpful to a human body by decomposing organic matter through action of microorganisms such as molds and bacteria. Representative examples of the fermented foods include various alcoholic beverages, dairy products such as yogurt and butter, and fermented soybean products.

Fermentation efficiency of these fermented foods may be determined depending on a contact rate between a fermentation target and air. However, in a fermentation tank according to the related art, a manner of supplying compressed air supplied from a large-sized air compressor through a sparger in the fermentation tank is used.

In more detail, the fermentation tank according to the related art includes the sparger and an impeller. The sparger discharges bubbles through porous holes having a diameter of about 10 mm, delays a rapid rise or discharge of the bubbles discharged through a large-sized impeller into liquid, and thus increases residence times of the bubbles.

In this case, the diameter of the bubbles has no choice but to be larger than a certain size (10 mm to 12 mm), and thus the residence times of the bubbles become relatively short. Thus, a time during which the fermentation target making the fermented foods and the bubbles are in contact with each other is decreased, and thus a required fermentation time is increased. Further, a contact area between the fermentation target and the bubbles is reduced.

To solve these problems, it is tried to improve efficiency of contact with air using a stirrer. However, excessive power is consumed to operate a large-sized stirrer. A large amount of air should be introduced, strong stirring is required, and thus the stirrer and a power transmission device is frequently broken down.

### DISCLOSURE

### Technical Problem

Embodiments provide a bubble generating apparatus that may generate fine-sized bubbles and a fermentation tank including the same.

### Technical Solution

As an example, a bubble generating apparatus includes an impeller part including a plurality of blades that rotate about an axis extending in a reference direction and are arranged in a circumferential direction centered on the axis, and a stator part including a plurality of holes arranged outside a radius of the impeller part and arranged in the circumferential direction, wherein the stator part is spaced apart from the blade in a radially outward direction.

As another example, the bubble generating apparatus may further include a coupling part coupled to a side of the impeller part in a direction opposite to the reference direction, wherein the coupling part may include a rotating member that rotates the impeller part, and a welding plate which is disposed outside a radius of the rotating member, to which the rotating member is relatively rotatably coupled, and which is coupled to a portion of a tank in which the impeller part is disposed.

As still another example, the bubble generating apparatus may include an operation part that is coupled to the rotating member, is disposed outside the tank, and rotates the rotating member.

As yet another example, the impeller part may include a plurality of first magnet members arranged in the circumferential direction centered on the axis, and the rotating member may include a plurality of second magnet members arranged at positions corresponding to the first magnet members and having polarities opposite to those of the first magnet members.

As yet another example, the stator part may further include a first stator member which is disposed outside the radius of the impeller part, has a circular shape when viewed in the reference direction, and covers the plurality of blades, in which the plurality of holes are arranged on a side surface thereof in the circumferential direction and the reference direction, and which has a communication hole formed on an upper surface thereof, and a second stator member coupled to the first stator member in the reference direction, extending upward, and having a communication passage formed therein that is penetrated vertically and communicates with the communication hole.

As yet another example, the side surface of the first stator member may be spaced a distance of 0.9 mm to 3.1 mm from the blade in the radially outward direction.

As yet another example, the blade may include a first portion of which a length is increased in the reference direction as the first portion is moved in the radially outward direction.

As yet another example, the first portion may start from a portion of the blade closest to a center of the stator part.

As yet another example, the blade may have a convex shape in the circumferential direction when viewed in the reference direction.

As yet another example, when a space formed between a pair of blades adjacent to each other is referred to as a blade passage, the blade passage may have a shape of which a width is increased in the radially outward direction.

As yet another example, the impeller part may further include a first impeller member having a first diameter and extending in the reference direction, a second impeller member which extends from the first impeller member in the reference direction and of which a diameter is decreased from the first diameter to a second diameter in the reference direction, and a third impeller member extending from the second impeller member in the reference direction and having the second diameter.

As yet another example, the impeller part may further include a first passage formed through the second impeller member and extending in an inclined direction in the radially outward direction in the reference direction, and a second passage formed through the third impeller member and extending in the radially outward direction.

As yet another example, the impeller part may further include a third passage formed through the first to third impeller members in the reference direction and communicating with the first passage and the second passage.

As yet another example, the impeller part may further include a fourth impeller member coupled to the third impeller member in the reference direction and coupled to the plurality of blades.

As an example, a fermentation tank includes a tank in which an internal space is formed, a stirrer that is disposed in the internal space and stirs a content in the internal space, a bubble generating apparatus that is coupled to one surface of the tank and generates bubbles in the internal space, and an air injecting device that injects air into the bubble generating apparatus, wherein the bubble generating apparatus includes an impeller part disposed in the internal space and including a plurality of blades that rotate about an axis extending in a reference direction and are arranged in a circumferential direction centered on the axis, and a stator part including a plurality of holes arranged outside a radius of the impeller part and arranged in the circumferential direction.

As another example, the bubble generating apparatus may be provided

in plurality.

As still another example, the plurality of bubble generating apparatuses may be selectively operated.

As yet another example, when viewed in the reference direction, the stirrer may be disposed to overlap the bubble generating apparatus.

### Advantageous Effects

According to the present disclosure, because a blade and a stator part are spaced apart from each other in a radially outward direction, air disposed in a separation space therebetween may be crushed into fine-sized bubbles by the blade, and thus residence times of and contact areas between the bubbles in a liquid may be increased, and fermentation efficiency may be increased.

### DESCRIPTION OF DRAWINGS

FIG. 1 is a view illustrating a fermentation tank to which a bubble generating apparatus is coupled according to an embodiment of the present disclosure.

FIG. 2 is a perspective view illustrating the bubble generating apparatus according to the embodiment of the present disclosure.

FIG. 3 is an exploded perspective view of FIG. 2.

FIG. 4 is a cross-sectional view illustrating the bubble generating apparatus according to the embodiment of the present disclosure.

FIG. 5 is a cross-sectional view of an impeller part.

FIG. 6 is a perspective view illustrating a plurality of blades.

FIG. 7 is a view illustrating a state in which the bubble generating apparatus is coupled to a tank of the fermentation tank according to the embodiment of the present disclosure.

### MODE FOR INVENTION

Hereinafter, some embodiments of the present disclosure will be

described in detail with reference to the exemplary drawings. When components in the drawings are designated by reference numerals, the same components have the same reference numerals as far as possible even though the components are illustrated in different drawings. Further, in description of the embodiments of the present disclosure, when it is determined that a detailed description of a related well-known configuration or function disturbs understanding of the embodiments of the present disclosure, the detailed description will be omitted.

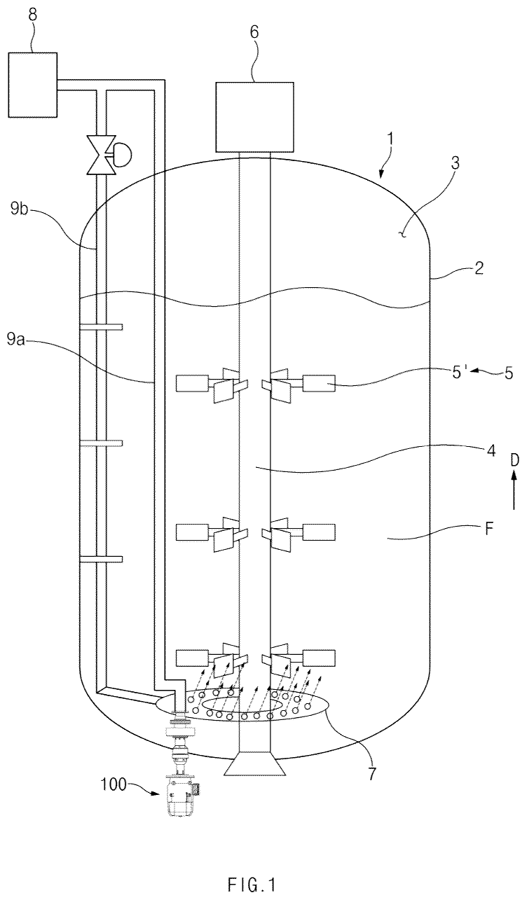

FIG. 1 is a view illustrating a fermentation tank 1 to which a bubble generating apparatus 100 is coupled according to an embodiment of the present disclosure. The bubble generating apparatus 100 according to the embodiment of the present disclosure may be the bubble generating apparatus 100 mounted on the fermentation tank 1. The fermentation tank 1 may mean an apparatus for fermenting a fermentation target “F.” The fermentation target “F” may mean a substance that is fermented to become various alcoholic beverages, dairy products, vinegar, or the like.

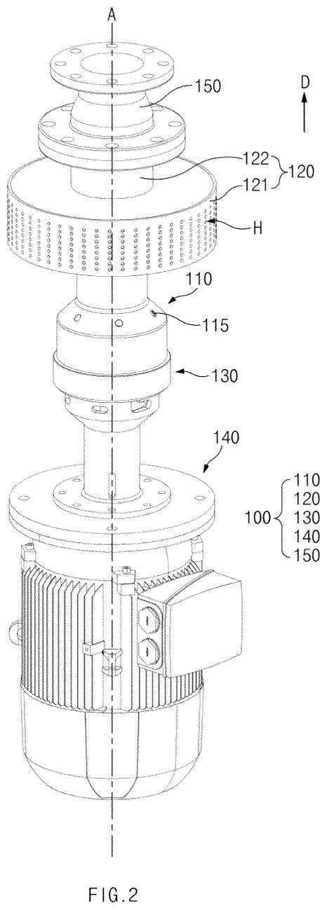

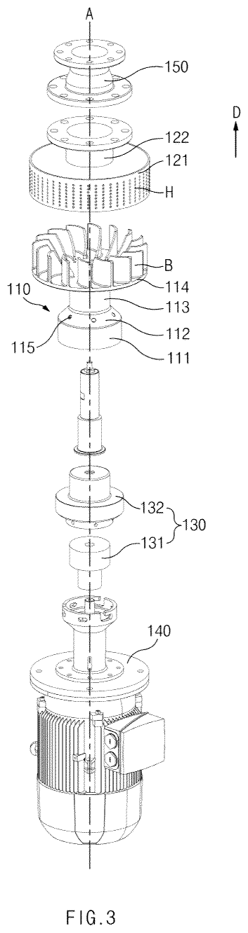

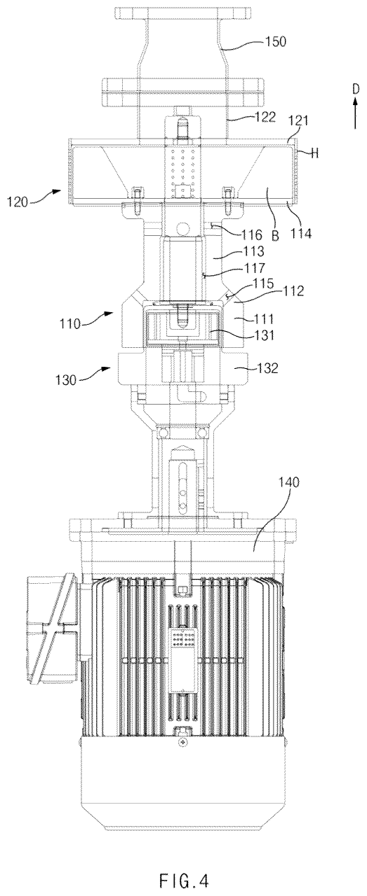

FIG. 2 is a perspective view illustrating the bubble generating apparatus according to the embodiment of the present disclosure. FIG. 3 is an exploded perspective view of FIG. 2. FIG. 4 is a cross-sectional view illustrating the bubble generating apparatus according to the embodiment of the present disclosure.

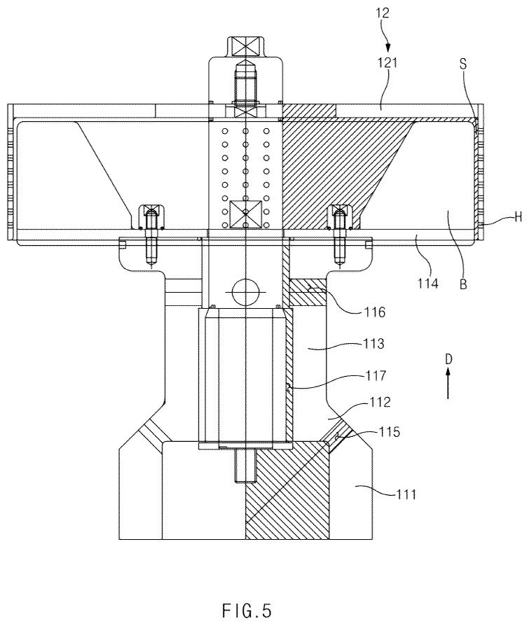

The bubble generating apparatus 100 according to the embodiment of the present disclosure may include an impeller part 110 and a stator part 120. As illustrated in FIG. 1, the impeller part 110 and the stator part 120 may be arranged inside a tank 2 of the fermentation tank 1. FIG. 5 is a cross-sectional view of an impeller part.

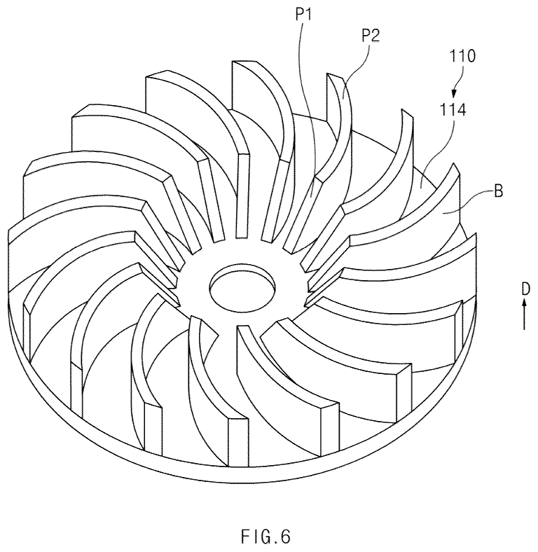

FIG. 6 is a perspective view illustrating a plurality of blades “B.” The impeller part 110 may include the plurality of blades “B.” The plurality of blades “B” may be rotated about an axis “A” extending in a reference direction “D.” As an example, the reference direction “D” may be an upward direction but the present disclosure is not limited thereto. The plurality of blades “B” may be arranged in a circumferential direction centered on the axis “A.” Hereinafter, the circumferential direction may mean a circumferential direction of an imaginary circle centered on the axis “A.”

The blade “B” may include a first portion P1 of which a length increases in the reference direction “D” as the first portion P1 moves in an outer radial direction. In this case, the first portion P1 may start from a portion of the blade “B” closest to a center of the stator part 120. A second portion P2 having a constant length in the reference direction “D” may be formed outside a radius of the first portion P1.

The blade “B” may have a convex shape in the circumferential direction when viewed from the reference direction “D.” As an example, as illustrated in FIG. 6, a shape of the blade “B” viewed in the reference direction “D” may be similar to a shape of the parenthesis. Arrangement of the blades “B” may be of a backward type.

In the case of a straight type blade, when the blade “B” is used in a large-capacity tank, air flow efficiency is poor as compared to the backward type, and thus application to the fermentation tank of the present disclosure is not suitable, and a power load is also high. For this reason, in the case of the present disclosure, it is preferable that the backward type blade “B” having effects of low noise, low vibration, and low power load is used.

Further, when a space formed between a pair of blades adjacent to each other is referred to as a blade passage, the blade passage may have a shape of which a width is increased in a radially outward direction.

The stator part 120 may be disposed outside a radius of the impeller part 110. The stator part 120 may include a plurality of holes “H” arranged in the circumferential direction. As an example, the hole “H” may have a circular shape, but the present disclosure is not limited thereto, and the hole “H” may have various shapes such as a long hole and a polygon.

The stator part 120 may be spaced apart from the blade “B” in the radially outward direction. Hereinafter, the radially outward direction may mean a direction toward an outside of a radius of the imaginary circle centered on the axis “A.”

As an example, the stator part 120 may be spaced a distance of 0.9 mm to 3.1 mm from the blade “B.”

In FIG. 5, hatched portions may mean portions that communicate with each other. As illustrated in FIG. 5, a separation space “S” may be provided between the stator part 120 and the blade “B.” Air may stagnate in the separation space “S” in a moment. Thereafter, the stagnating air may be crushed into fine-sized bubbles while passing through the hole “H” as the impeller part 110 is rotated, and the crushed fine-sized bubbles may be discharged into the tank 2 of the fermentation tank 1.

For example, the diameter of the bubbles may be 3 mm or less. Because the diameter of the bubbles is reduced to 3 mm or less, the amount of dissolved oxygen in the fermentation tank 1 may be improved.

According to the present disclosure, because the fine-sized bubbles may be generated, residence times of and contact areas between the bubbles may be increased, and thus fermentation efficiency may be increased. For example, when it is assumed that the bubble has a sphere shape, a value obtained by dividing a surface area by a volume is inversely proportional to a radius. That is, as the radius is decreased, the surface area may be increased as compared to the volume.

In the case of the present disclosure, because the diameter of the bubbles is 3 mm or less, the bubbles have a diameter that is reduced by three times to four times as compared to the bubbles according to the related art, the value obtained by dividing the surface area by the volume is increased by three times to four times, and thus oxygen usage efficiency may be increased. Hereinafter, a specific structure of the bubble generating apparatus 100 will be described in more detail.

### Coupling Part 130

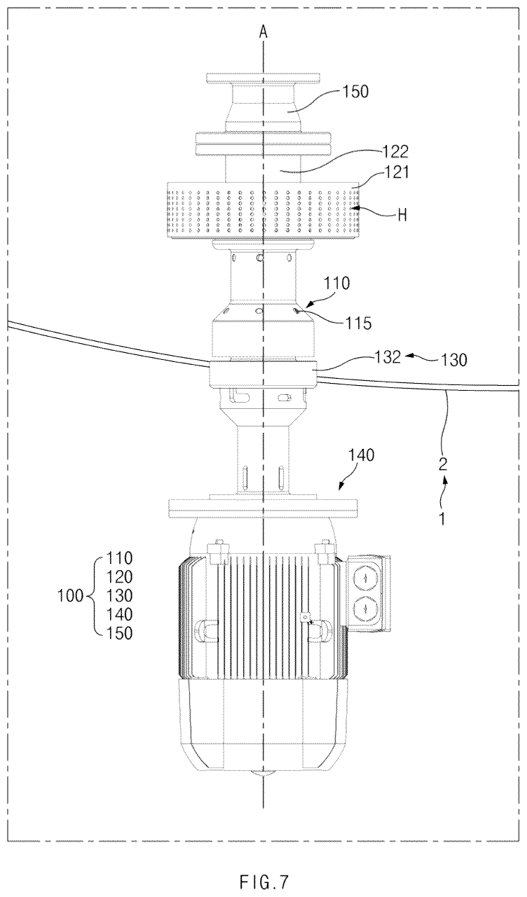

FIG. 7 is a view illustrating a state in which the bubble generating apparatus is coupled to a tank of the fermentation tank according to the embodiment of the present disclosure. The bubble generating apparatus 100 according to the embodiment of the present disclosure may further include a coupling part 130. The coupling part 130 may be coupled to a side of the impeller part 110 in a direction opposite to the reference direction “D.” The coupling part 130 may be a structure for mounting the bubble generating apparatus 100 on the fermentation tank 1.

The coupling part 130 may include a rotating member 131 (see FIG. 3) and a welding plate 132 (see FIG. 3). The rotating member 131 may be provided to rotate the impeller part 110. The rotating member 131 may be rotated relative to the welding plate 132.

As an example, the impeller part 110 and the rotating member 131 may be coupled through a magnetic force. As an example, the impeller part 110 may include a plurality of first magnet members (not illustrated). The first magnetic members may be arranged in the circumferential direction about the axis “A.” Further, the rotating member 131 may include a plurality of second magnet members. The second magnet members (not illustrated) may be arranged in positions corresponding to the first magnet members but may have polarities opposite to those of the first magnet members. As an example, the first magnet members may be arranged to surround the second magnet members.

In this case, the rotating member is rotated, and thus, the plurality of second magnet members are rotated together. An attractive force or repulsive force interacts with the first magnetic members due to the rotation of the second magnet member to also rotate the first magnet members together. The rotation of the first magnet members together may mean that the impeller part 110 is rotated.

The welding plate 132 may be disposed outside a radius of the rotating member 131. The welding plate 132 may be coupled to a portion of the tank 2.

As an example, a coupling hole formed through the tank 2 in a size corresponding to the welding plate 132 may be formed, and the welding plate 132 may be welded and coupled to the coupling hole.

### Operation Part 140

The bubble generating apparatus 100 according to the embodiment of the present disclosure may further include an operation part 140. The operation part 140 may be coupled to the rotating member 131, be disposed outside the tank 2, and rotate the rotating member 131. The operation part 140 may be a motor that is operated by receiving power from an external part.

### Stator Part 120

The stator part 120 may include a first stator member 121 and a second stator member 122. The first stator member 121 may be disposed outside the radius of the impeller part 110 and may have a circular shape when viewed from the reference direction “D.” The first stator member 121 may cover the plurality of blades “B” when viewed from the reference direction “D.”

The plurality of holes “H” may be arranged on a side surface of the first stator member 121 in a circumferential direction and the reference direction “D.” Further, the first stator member 121 may have a communication hole formed on an upper surface thereof. The side surface of the first stator member 121 may be spaced apart from the blade “B” in the radially outward direction.

As an example, the side surface of the first stator member 121 may be spaced a distance of 0.9 mm to 3.1 mm from the blade “B” in the radially outward direction.

The second stator member 122 may be coupled to the first stator member 121 in the reference direction “D,” and may extend upward. A communication passage that is penetrated vertically and communicates with the communication hole may be formed inside the second stator member 122. The second stator member 122 may be connected to a connection pipe part 150, which will be described below.

To increase the amount of dissolved oxygen in the fermentation tank 1, a method of increasing the number of rotations of a stirrer or increasing an air supply amount may be used. Among the methods, a method most commonly used for increasing the amount of dissolved oxygen is a method of increasing the number of rotations of the stirrer. However, in this method, the stirrer directly hits the fermentation target “F” inside the fermentation tank 1, and thus a stress applied to a strain may be increased. Further, when recent high-quality new strains are used, productivity may be decreased.

The bubble generating apparatus according to the embodiment of the present disclosure has the stator part 120 including the first stator member 121 having the plurality of holes “H” on a side surface thereof and surrounding the impeller part 110. Thus, the impeller part 110 does not directly stir a solution inside the fermentation tank 1, the impeller part 110 crushes air transferred to the impeller part 110 through the connection pipe part 150, which will be described below, and the crushed air is transferred to the fermentation target “F.” Thus, the stress applied to the strain may be greatly reduced.

Accordingly, the number of rotations of the existing impeller part that is operated at a high speed to crush the air may be greatly decreased, and thus power may be decreased.

### Connection Pipe Part 150

The connection pipe part 150 may be coupled to the stator part 120 in the reference direction “D” and may be connected to an air injecting device 8 for injecting air into the stator part 120. As an example, the connection pipe part 150 may have a structure of which a diameter is decreased in the reference direction “D,” but the present disclosure is not necessarily limited thereto, and the connection pipe part 150 may have various shapes as long as the connection pipe part 150 is connected to the air injecting device 8.

### Impeller Part 110

The impeller part 110 may include first to third impeller members 111, 112, and 113. The first impeller member 111 may have a first diameter and may extend in the reference direction “D.”

The second impeller member 112 may extend from the first impeller member 111 in the reference direction “D” and may have a shape of which a diameter is decreased from the first diameter to a second diameter as it goes in the reference direction “D.” In this case, the second diameter may be smaller than the first diameter.

The third impeller member 113 may extend from the second impeller member 112 in the reference direction “D” and may have the second diameter.

The impeller part 110 may further include a fourth impeller member 114. The fourth impeller member 114 may be coupled to the third impeller member 113 in the reference direction “D.” The fourth impeller member 114 may be coupled to the plurality of blades “B.” As an example, the plurality of blades “B” may be seated on the fourth impeller member 114 in the reference direction “D.”

However, the first to fourth impeller members 111, 112, 113, and 114 are not necessarily limited to being separated from each other, and even when the first to fourth impeller members 111, 112, 113, and 114 are integrally formed with each other or only some of them are separate components, both the two cases should be considered to belong to the scope or rights of the present disclosure.

As illustrated in FIG. 5, the impeller part 110 may include a first passage 115 and a second passage 116. The first passage 115 may be formed through the second impeller member 112 and extend in an inclined direction in the radially outward direction in the reference direction “D.” The second passage 116 may be formed through the third impeller member 113 and extend in the radially outward direction.

The impeller part 110 may further include a third passage 117. The third passage 117 may be formed through the first to third impeller members 111, 112, and 113 in the reference direction “D” and may communicate with the first passage 115 and the second passage 116. Further, the third passage 117 may communicate with the outside of the impeller part 110. In FIG. 5, hatched portions may mean portions that communicate with each other. As illustrated in FIG. 5, the first passage 115 and the second passage 116 may communicate with the third passage 117.

The first to third passages 115, 116, and 117 may be understood as a structure for preventing dry running. The drying running may mean that, when a rotor, a pump, a rotary shaft or the like is rotated, the bubbles are introduced to cause damage to a rotating component. The bubbles introduced through the first to third passages 115, 116, and 117 may be discharged to the outside of the impeller part 110, and thus the dry running may be prevented.

Hereinafter, a movement path of air introduced from the outside of the tank 2 of the fermentation tank 1 will be described in detail based on the above-described components.

First, the air is introduced into the connection pipe part 150 through the external air injecting device 8. The air introduced into the connection pipe part 150 is introduced into the communication passage of the second stator member 122 in a direction opposite to the reference direction “D” and is introduced into the first stator member 121.

The air introduced into the first stator member 121 is moved in the radially outward direction, passes through a space between the first stator member 121 and the blade “B”, is crushed into the bubbles through the hole “H,” and is moved into the tank 2 of the fermentation tank 1.

### Fermentation Tank 1

Hereinafter, the fermentation tank 1 including the bubble generating apparatus 100 according to the embodiment of the present disclosure will be described based on the above description of the bubble generating apparatus 100. The detailed contents of the bubble generating apparatus 100 may refer to the above-described contents.

The fermentation tank 1 may include the tank 2, a stirrer 4, the bubble generating apparatus 100, and the air injecting device 8. An internal space 3 may be formed inside the tank 2. The fermentation target “F” may be disposed in the internal space 3.

The stirrer 4 may be disposed in the internal space 3 to stir the fermentation target “F” in the internal space 3. As an example, the stirrer 4 may have a form in which a plurality of rotary blade assemblies 5 having a plurality of rotary blades 5′ arranged in the circumferential direction are arranged in the reference direction “D.” The stirrer 4 may be connected to a rotation motor 6 for rotating the rotary blade 5′.

The bubble generating apparatus 100 may be coupled to one surface of the tank 2 to generate the bubbles in the internal space 3.

The air injecting device 8 may inject the air into the bubble generating apparatus 100. The air injecting device 8 may be disposed outside the tank 2. The air injecting device 8 may be connected to the bubble generating apparatus 100 through a first air injecting pipe 9a penetrating the tank 2.

Meanwhile, the fermentation tank 1 including the bubble generating apparatus 100 according to the embodiment of the present disclosure may include a sparger 7. The sparger 7 may be disposed below the rotary blade assembly 5. As an example, the sparger 7 may have a shape similar to a donut and may have a plurality of bubble generating holes formed on an outer surface thereof to generate the bubbles.

The sparger 7 may be connected to a second air injecting pipe 9b of the air injecting device 8. For example, 30% of the air discharged through the air injecting device 8 may be introduced into the sparger 7 through the second air injecting pipe 9b, and 70% of the air may be introduced into the bubble generating apparatus 100 through the first air injecting pipe 9a.

Meanwhile, the bubble generating apparatus 100 may be provided as a plurality of bubble generating apparatuses 100. For convenience of description, one bubble generating apparatus 100 is illustrated in the drawings. The plurality of bubble generating apparatuses 100 may be operated selectively. For example, a user may operate some bubble generating apparatuses 100 among the plurality of bubble generating apparatuses 100 depending on a degree to which the bubbles need to be injected into the tank 2.

As an example, the bubble generating apparatus 100 may be disposed adjacent to the rotary blade assembly positioned on a side opposite to the reference direction “D” among the rotary blade assemblies 5. When viewed in the reference direction “D,” the bubble generating apparatus 100 may be disposed to overlap the rotary blade assembly 5.

The above description is merely illustrative of the technical spirit of the present disclosure, and those skilled in the art to which the present disclosure belongs may make various modifications and changes without departing from the essential features of the present disclosure. Thus, the embodiments disclosed in the present disclosure are not intended to limit the technology spirit of the present disclosure, but are intended to describe the present disclosure, and the scope of the technical spirit of the present disclosure is not limited by these embodiments. The scope of protection of the present disclosure should be interpreted by the appended claims, and all technical spirits within the scope equivalent thereto should be interpreted as being included in the scope of the present disclosure.

1. A bubble generating apparatus comprising:
an impeller part including a plurality of blades configured to rotate about an axis extending in a reference direction and arranged in a circumferential direction centered on the axis; and
a stator part including a plurality of holes arranged outside a radius of the impeller part and arranged in the circumferential direction,
wherein the stator part is spaced apart from the blade in a radially outward direction.

2. The bubble generating apparatus of claim 1, further comprising:
a coupling part coupled to a side of the impeller part in a direction opposite to the reference direction,
wherein the coupling part includes:
a rotating member configured to rotate the impeller part; and
a welding plate which is disposed outside a radius of the rotating member, to which the rotating member is relatively rotatably coupled, and which is coupled to a portion of a tank in which the impeller part is disposed.

3. The bubble generating apparatus of claim 2, further comprising:
an operation part coupled to the rotating member, disposed outside the tank, and configured to rotate the rotating member.

4. The bubble generating apparatus of claim 3, wherein the impeller part includes a plurality of first magnet members arranged in the circumferential direction centered on the axis, and
wherein the rotating member includes a plurality of second magnet members arranged at positions corresponding to the first magnet members and having polarities opposite to those of the first magnet members.

5. The bubble generating apparatus of claim 1, wherein the stator part further includes:
a first stator member which is disposed outside the radius of the impeller part, has a circular shape when viewed in the reference direction, and covers the plurality of blades, in which the plurality of holes are arranged on a side surface thereof in the circumferential direction and the reference direction, and which has a communication hole formed on an upper surface thereof, and
a second stator member coupled to the first stator member in the reference direction, extending upward, and having a communication passage formed therein that is penetrated vertically and communicates with the communication hole.

6. The bubble generating apparatus of claim 5, wherein the side surface of the first stator member is spaced a distance of 0.9 mm to 3.1 mm from the blade in the radially outward direction.

7. The bubble generating apparatus of claim 1, wherein the blade includes a first portion of which a length is increased in the reference direction as the first portion is moved in the radially outward direction.

8. The bubble generating apparatus of claim 7, wherein the first portion starts from a portion of the blade closest to a center of the stator part.

9. The bubble generating apparatus of claim 7, wherein the blade has a convex shape in the circumferential direction when viewed in the reference direction.

10. The bubble generating apparatus of claim 9, wherein, when a space formed between a pair of blades adjacent to each other is referred to as a blade passage, the blade passage has a shape of which a width is increased in the radially outward direction.

11. The bubble generating apparatus of claim 1, wherein the impeller part further includes:
a first impeller member having a first diameter and extending in the reference direction;
a second impeller member which extends from the first impeller member in the reference direction and of which a diameter is decreased from the first diameter to a second diameter in the reference direction; and
a third impeller member extending from the second impeller member in the reference direction and having the second diameter.

12. The bubble generating apparatus of claim 11, wherein the impeller part further includes:
a first passage formed through the second impeller member and extending in an inclined direction in the radially outward direction in the reference direction; and
a second passage formed through the third impeller member and extending in the radially outward direction.

13. The bubble generating apparatus of claim 12, wherein the impeller part further includes:
a third passage formed through the first to third impeller members in the reference direction and communicating with the first passage and the second passage.

14. The bubble generating apparatus of claim 11, wherein the impeller part further includes:
a fourth impeller member coupled to the third impeller member in the reference direction and coupled to the plurality of blades.

15. A fermentation tank comprising:
a tank in which an internal space is formed;
a stirrer disposed in the internal space and configured to stir a content in the internal space;
a bubble generating apparatus coupled to one surface of the tank and configured to generate bubbles in the internal space; and
an air injecting device configured to inject air into the bubble generating apparatus,
wherein the bubble generating apparatus includes:
an impeller part disposed in the internal space and including a plurality of blades configured to rotate about an axis extending in a reference direction and arranged in a circumferential direction centered on the axis; and
a stator part including a plurality of holes arranged outside a radius of the impeller part and arranged in the circumferential direction.

16. The fermentation tank of claim 15, wherein the bubble generating apparatus is provided in plurality.

17. The fermentation tank of claim 16, wherein the plurality of bubble generating apparatuses are selectively operated.

18. The fermentation tank of claim 16, wherein, when viewed in the reference direction, the stirrer is disposed to overlap the bubble generating apparatus.
